(19) United States
(12) Patent Application Publication
(10) Pub. No.: US 2006/0285331 A1
(43) Pub. Date: Dec. 21, 2006

(54) Projecting device with energy recycling function

(75) Inventors: Bang-Ji Wang, Taipei City (TW); Chang-Chien Li, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/391,957

(22) Filed: Mar. 29, 2006

(30) Foreign Application Priority Data
Jun. 15, 2005 (TW) 94119907

(51) Int. Cl. F21V 29/00

(52) U.S. Cl. 362/294; 362/373

(57) ABSTRACT

A projecting device with energy recycling function comprises a power system, a light source, an optical engine, a lens and an energy recycling module. The light source which receives power from the power system is for generating a beam of light. The optical engine which receives power from the power system is for guiding the light generated by the light source. The lens is for receiving the light guided by the optical engine to generate a projecting image, and the light forms a light path from the light source to the lens via the optical engine. The energy recycling module is for recycling at least one of heat energy and light energy generated by at least one of the light source and the optical. engine.

This application claims the benefit of Taiwan application Serial No. 94119907, filed Jun. 15, 2005, the subject matter of which is incorporated herein by reference.

### BACKGROUND OF THE INVENTION

1. Field of the Invention

The invention relates in general to a projecting device, and more particularly to a projecting device with energy recycling function.

2. Description of the Related Art

Projecting devices, such as projectors, are widely applied in offices, conferences, laboratories, schools and even family theaters.

A common projector mainly comprises a power system, a light source, an optical engine and a lens. The power system mainly supplies power to the light source and components in the optical engine. The light emitted from the light source is transmitted through the optical engine and projected out to form a projecting image via the lens. However, the light source generates lots of heat in the light emitting process. If the temperature inside the projector gets too high, electronic components in the projector will be damaged, thereby generating an error operation.

A method for solving the error operation issue of the electronic components in the projector under high temperature is to lower the temperature by using one or more fans. The fan is actuated by the power system to achieve the purpose of dissipating redundant heat. However, for the heat is a kind of energy like the light, too much heat or light wasted will reduce power utilizing efficiency of the projector.

### SUMMARY OF THE INVENTION

It is therefore an object of the invention to provide a projecting device with energy recycling function to reduce energy waste by recycling redundant heat or light.

The invention achieves the above-identified object by providing a projecting device with energy recycling function. The projecting device comprises a power system, a light source, an optical engine, a lens and an energy recycling module. The light source which receives power from the power system is for generating a beam of light. The optical engine which receives power from the power system is for guiding the light generated by the light source. The lens is for receiving the light guided by the optical engine to generate a projecting image, and the light forms a light path from the light source to the lens via the optical engine. The energy recycling module is for recycling at least one of heat energy and light energy generated by at least one of the light source and the optical engine.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a block diagram of a projecting device according to the first embodiment.

FIG. 1B is a schematic diagram of the energy recycling module according to the first embodiment of the invention.

FIG. 1C is a schematic diagram of a flow-path system practically disposed in the projecting device.

FIG. 2 is a configuration diagram of a thermoelectric semiconductor according to the second embodiment of the invention.

FIG. 3A is a relation diagram between the pressure and specific volume of a Stirling engine according to the third embodiment of the invention.

FIG. 3B is a schematic diagram of a piston moving in the Stirling engine according to the third embodiment of the invention.

FIG. 4 is a schematic operation diagram of a photo-thermal micro-mechanic pump according to the forth embodiment of the invention.

### DETAILED DESCRIPTION OF THE INVENTION

Energy can be generated in many forms, such as in the form of electric energy, mechanic energy, light energy, heat energy and chemical energy, etc. The input energy of the projecting device is mainly electric energy provided by a power system, but its output energy comprises kinetic energy of the rotating fan, heat energy of high-temperature light source, light energy of high-luminance light source and mechanic energy of other driving components and so on. In the following, a number of embodiments are used to explain various energy recycling methods.

### Embodiment One

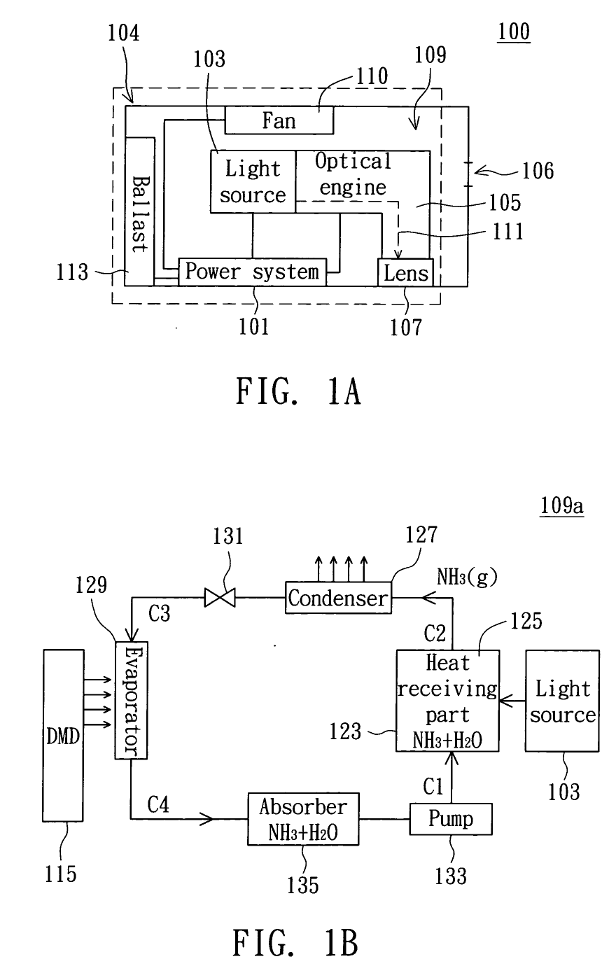

Referring to FIG. 1A, a block diagram of a projecting device according to the first embodiment is shown. The projecting device 100 mainly comprises a power system 101, a light source 103, an optical engine 105, a lens 107, and an energy recycling module (in the dotted part of FIG. 1A) 109. The power system 101 supplies powers to main components, such as the light source 103 and the optical engine 105, and supplies electric power to a fan 110 and a ballast 113. The ballast 113 is for stabilizing rectification and lighting up the light source 103. The light emitted by the light source 103 is guided by the optical engine 105 to from a projecting image via the lens 107. The light path 111 is formed as the light goes from the light source 103 to the lens 107 via the optical engine 105. The casing 104 of the projecting device 100 covers the light source 103, the optical engine 105, and the lens 107. Moreover, an opening 106 is formed on the casing 104 of the projecting device 100.

Referring to FIG. 1B and FIG. 1C simultaneously, FIG. 1B is a schematic diagram of the energy recycling module according to the first embodiment of the invention. FIG. 1C is a schematic diagram of a flow-path system practically disposed in the projecting device. In the embodiment, a flow-path system 109a is used as a main system for recycling the heat energy. The flow-path system 109a is mainly used for absorbing heat and cooling some high-temperature components. In the projecting device 100, the temperature of the light source 103 is normally the highest. Besides, the temperature of the digital micro-mirror device (DMD) 115 which is part of the optical engine 105 in FIG. 1A and the ballast 113 is also very high. The flow-path system 109a configured in the embodiment uses redundant heat generated by the light source 103 as a heating source to dissipate heat of other high-temperature electronic components, such as the DMD 115, to achieve the purpose of recycling the heat released by the projecting device 100.

The flow-path system 109a comprises a piping 121, a coolant 123, a heat receiving part 125, a condenser 127, an evaporator 129, an expansion valve 131, and an absorber 135. The evaporator 129, the heat receiving part 125 and the condenser 127 are connected through the piping 121 and the condenser 127 is located between the heat receiving part 125 and the evaporator 129. The liquid coolant 123 absorbs heat to evaporate into a gaseous state when the liquid coolant 123 flows through the heat receiving part 125. The gaseous coolant 123 is cooled down to condense to a liquid state when the gaseous coolant 123 flows through the condenser 127. The liquid coolant 123 absorbs heat again to evaporate into the gaseous state when the liquid coolant 123 flows through the evaporator 129. Then, the gaseous coolant 123 dissolves in the liquid coolant 123 in the piping 121 and flows back to the heat receiving part 125. The coolant may be ammonia water (NH₃+H₂O) for instance. The circulation of the flow-path system 109a can be divided into four procedures. In the first procedure Cl, the liquid coolant 123 is heated to be gaseous coolant (NH₃(g)) 123 when the liquid coolant 123 flows through the heat receiving part 125. In the second procedure C2, the high-temperature and high-pressure gaseous coolant (NH₃(g)) 123 releases heat to transform into the liquid state when the gaseous coolant 123 flows through the condenser 127. In the third procedure C3, the temperature and pressure of the liquid coolant 123 is lowered down as it flows by the expansion valve 131, and the low-temperature and low-pressure liquid coolant NH₃(l) 123 in the evaporator 129 absorbs heat to form the gaseous coolant (NH₃(g)) 123. In the forth procedure C4, the gaseous coolant 123 dissolves in water in the absorber 135 to form the liquid coolant (NH₃+H₂O) 123, and the liquid coolant 123 is then pumped into the high-pressure heat receiving part 125 by a pump 133 to enter the circulation again. The absorber 135 is connected between the heat receiving part 125 and the evaporator 129, and located at a different side of the piping 121 relative to where the condenser 127 is located. A vaporizer and a regenerator (not shown in the figure) can be further disposed between the absorber 135 and the condenser 127 for recycling water.

In the circulation, the heat of the heat receiving part 125 comes from the redundant heat generated by the light source 103. Therefore, it would be better to dispose the heat receiving part 125 near the light source 103, such as at one side of the light source 103. Meanwhile, the electronic component needed to be cooled, such as the DMD 115, can be disposed near the evaporator 129 in the flow-path system 109a such that the coolant 123 can take away the heat of the high-temperature DMD 115. For example, the DMD 115 may be disposed at one side of the evaporator 129. In the recycling process, there may be still a small amount of redundant heat needed to be released at the surroundings of the condenser 127, and the opening 106 of the casing 104 can be used to release the heat. For example, the opening 106 may be disposed at one side of the condenser 127. In the embodiment, no extra electric power or kinetic power is required in recycling the redundant light and heat for further usage, thereby achieving the purpose of energy recycling.

### Embodiment Two

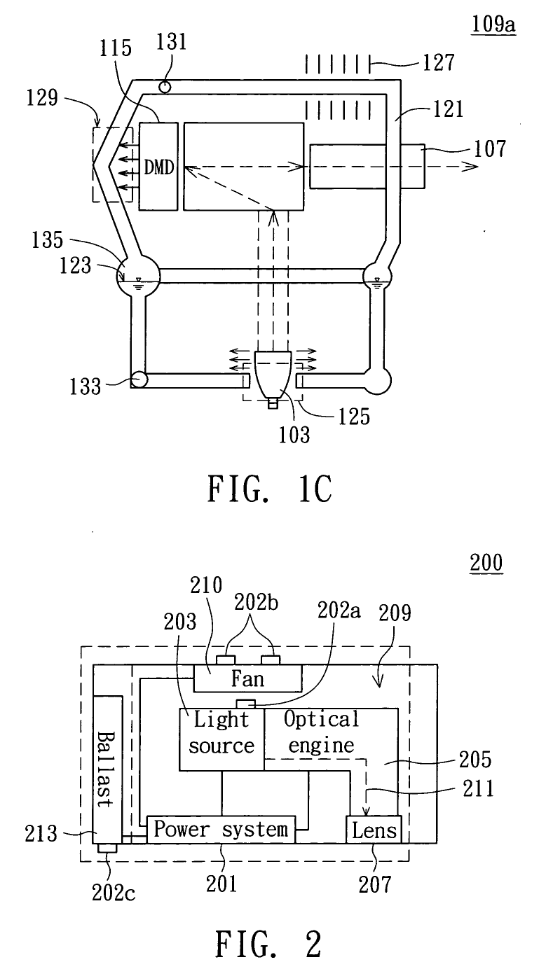

Referring to FIG. 2, a configuration diagram of a thermoelectric semiconductor according to the second embodiment of the invention is shown. Different from the first embodiment, thermoelectric semiconductors 202a-202c are further added to the flow-path system 109a for absorbing heat and transforming the heat into electric energy. In the projecting device 200, the region having higher temperature difference can be found out according to the temperature distribution. For example, the temperature nearby the light source 203 is usually higher than the temperature relatively away from the light source 203, and the temperature difference in that region would be higher. Therefore, the heat propagating effect at this region will be better and the thermoelectric semiconductor 202a disposed therein can have a higher energy recycling efficiency. For example, the thermoelectric semiconductor 202a may be disposed at one side of the light source 203. The thermoelectric semiconductor 202b is disposed in the neighborhood of the fan for there is also a higher heat flow rate and higher temperature difference between the region and the fan. For example, the thermoelectric semiconductor 202b may be disposed at one side of the fan. For the same reason, the thermoelectric semiconductor 202c is disposed in the neighborhood of the ballast 213, such as at one side of the ballast 213. When applied to the flow-path system 109a of the first embodiment, the thermoelectric semiconductor 202a-202c can be disposed at the evaporator 129 or the condenser 127. Heat is transformed into electric energy by the thermoelectric semiconductor 202a-202c and the recycling electric energy can be fed back to the power system 201 for further usage or be directly used for driving other electronic components.

### Embodiment Three

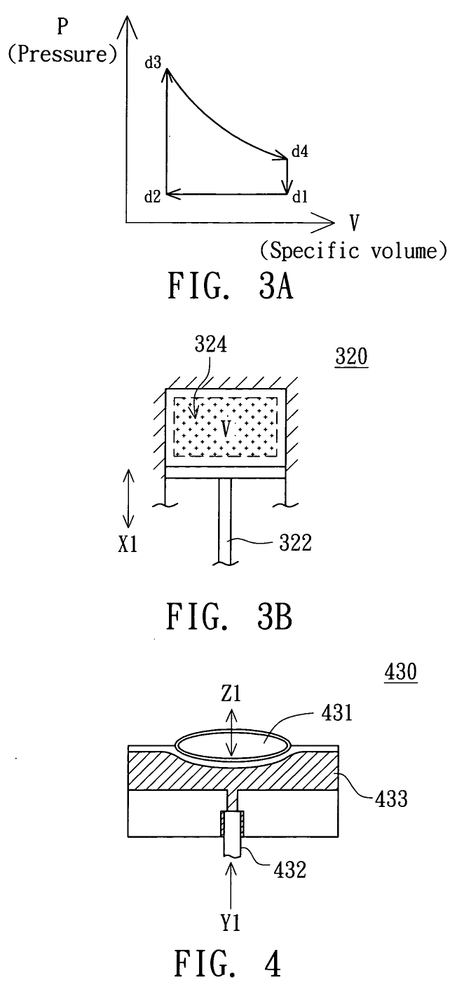

Different from the flow-path system 109a, the heat recycling method of the embodiment is performed by using a Stirling engine. Referring to FIG. 3A and FIG. 3B, FIG. 3A is a relation diagram between the pressure and specific volume of the Stirling engine according to the third embodiment of the invention. FIG. 3B is a schematic diagram of a piston motion in the Stirling engine according to the third embodiment of the invention. Similar to the first embodiment, the Stirling engine 320 is disposed in the neighborhood of the light source, such as at one side of the light source. The Stirling engine 320 may be disposed at one side of the optical engine as well due to the same reason. Gas in the Stirling engine 320 is heated to push the piston 322 to move back and forth in the direction X1 by the high-temperature light source or other electronic components, wherein P is the pressure, V is the specific volume and P×V is the work. By continuously changing the specific volume V and/or the pressure P among the compression state d1, the heat absorption state d2, the expansion state d3, and the heat liberation state d4, the piston 322 can continuously move and produce work (kinetic energy). The gas to be heated can be helium gas or hydrogen gas. The kinetic energy produced can be used to drive the pump 133 in the first embodiment or be transformed into electric energy to be fed back to the power system 101 for further usage or be directly used for driving other electronic components.

### Embodiment Four

Different from the first, the second, and the third embodiments for recycling heat energy, in the forth embodiment, light energy is recycled in addition to heat energy. In the forth embodiment, a device such as a solar energy plate or a photo-thermal micro-mechanic pump may be disposed on the light path, especially near the light source which has the most light energy lost, thereby recycling more light energy. For example, a solar energy plate or a photo-thermal micro-mechanic pump may be disposed at one side of the light source or one side of the light path. The solar energy plate can transform light energy into electric energy for further usage. Referring to FIG. 4, a schematic operation diagram of the photo-thermal micro-mechanic pump according to the forth embodiment of the invention is shown. The photo-thermal micro-mechanic pump 430 comprises a movement part 431, a fluid 433 and a light receiving part 432. When the light receiving part 432 receives light from the direction Y1, the light is transformed into heat by the light receiving part 432. The movement part 431 moves back and forth in the direction z1 to generate kinetic energy due to the mechanism of expansion when hot and shrink when cold in the fluid 433 located between the movement part 431 and the light receiving part 432. The kinetic energy can be used in many applications, such as transformed into electric energy for storage or for the usage of other electronic components. The kinetic energy can also be supplied to the pump 133 in the first embodiment for driving the coolant 123 of the flow-path system 109a to reinforce flowing of the coolant 123. The light receiving part 432 may be optical fiber for instance.

As long as the energy recycling module is suitably configured, power of the rotation device, such as a fan, can be supplied by the energy device, such as a photo-thermal micro-mechanic pump or a solar energy plate, thereby saving electric energy.

The projecting device with energy recycling function disclosed by the embodiments of the invention can recycle light energy by using the solar energy or photo-thermal micro-mechanic pump, and recycle heat energy by using the flow-path system, the Stirling engine or the thermoelectric semiconductor. The flow-path system can be used together with the thermoelectric semiconductor, the solar plate and/or the photo-thermal micro-mechanic pump to recycle both the light energy and the heat energy. Therefore, not only the effect of cooling electronic components by the flow-path system can be achieved, but also the recycling heat or light energy can be transformed into kinetic energy or electric energy for driving the fan, the fluid or even other electronic components. By using the energy recycling module, the projecting device can achieve environmental protection purpose and have higher competition ability.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projecting device with energy recycling function, comprising:
a power system;
a light source, receiving power from the power system to generate a beam of light;
an optical engine, receiving power from the power system to guide the light generated by the light source;
a lens, for receiving the light guided by the optical engine to generate a projecting image, the light forming a light path from the light source to the lens via the optical engine; and
an energy recycling module, for recycling at least one of heat energy and light energy generated by at least one of the light source and the optical engine.

2. The device according to claim 1, wherein the energy recycling module comprises a thermoelectric semiconductor for transforming the heat energy into electric energy.

3. The device according to claim 2, wherein the thermoelectric semiconductor is disposed at one side of the light source.

4. The device according to claim 2, wherein the thermoelectric semiconductor is disposed at one side of the optical engine.

5. The device according to claim 2, wherein the electric energy transformed from the heat energy is fed back to the power system.

6. The device according to claim 1, wherein the energy recycling module comprises a solar energy plate for transforming the light energy into electric energy.

7. The device according to claim 6, wherein the solar energy plate is disposed near the light source.

8. The device according to claim 6, wherein the solar energy plate is disposed near the light path.

9. The device according to claim 6, wherein the electric energy transformed from the light energy is fed back to the power system.

10. The device according to claim 1, wherein the energy recycling module comprises a flow-path system configured according to the heat energy in the device, the flow-path system comprises:
a piping;
a coolant, flowing in the piping;
a heat receiving part;
a condenser; and
an evaporator, wherein the evaporator, the heat receiving part and the condenser are connected through the piping, and the condenser is located between the heat receiving part and the evaporator;
wherein the coolant is transformed from a liquid state into a gaseous state when the coolant flows by the heat receiving part and absorbs the heat energy, the coolant is then transformed from the gaseous state to the liquid state when the coolant flows by the condenser and releases heat, the coolant is then transformed from the liquid state into the gaseous state when the coolant flows by the evaporator and absorbs the heat, and the coolant in the gaseous state dissolves in the coolant in the liquid state in the piping and flows back to the heat receiving part.

11. The device according to claim 10, wherein the coolant is ammonia water.

12. The device according to claim 10, wherein the heat receiving part is disposed near the light source.

13. The device according to claim 10, wherein the evaporator is disposed near the optical engine.

14. The device according to claim 10, wherein the flow-path system further comprises an absorber connected between the heat receiving part and the evaporator through the piping and located at a different side of the piping relative to where the condenser is located, for helping the coolant in the gaseous state to dissolve in the coolant in the liquid state.

15. The device according to claim 10, wherein the energy recycling module further comprises a thermoelectric semiconductor, disposed near the condenser, for transforming the heat energy released by the condenser as the coolant flows by into electric energy.

16. The device according to claim 15, wherein the electric energy transformed from the heat energy is fed back to the power system.

17. The device according to claim 10, further comprising a casing for covering the power system, the light source, the optical engine, the lens and the energy recycling module, wherein the casing has at least an opening, and the condenser is disposed near the opening.

18. The device according to claim 10, wherein the flow-path system further comprises a photo-thermal micro-mechanic pump having a movement part and a light receiving part, the movement part is disposed inside the piping, the light receiving part is disposed outside the piping, and the photo-thermal micro-mechanic pump receives the light energy by the light receiving part and generates kinetic energy by the movement part to drive the coolant to flow in the piping.

19. The device according to claim 18, wherein the light receiving part of the photo-thermal micro-mechanic pump is disposed near the light path.

20. The device according to claim 1, wherein the energy recycling module further comprises a Stirling engine for transforming the heat energy into kinetic energy.

21. The device according to claim 20, wherein the Stirling engine is disposed near the light source.

22. The device according to claim 20, wherein the Stirling engine is disposed near the optical engine.

23. The device according to claim 20, further comprising a rotation device, disposed at one side of the light source, wherein the rotation device is driven by the kinetic energy.

24. The device according to claim 23, wherein the rotation device is a fan.
